(19) United States
(12) Patent Application Publication
(10) Pub. No.: US 2021/0129590 A1
(43) Pub. Date: May 6, 2021

(54) SYSTEM AND METHOD FOR ALTERING TIRE NOISE

(71) Applicant: Atturo Tire Corp., Waukegan, IL (US)

(72) Inventor: Michael Mathis, Wadsworth, IL (US)

(73) Assignee: Atturo Tire Corp., Waukegan, IL (US)

(21) Appl. No.: 17/089,195

(22) Filed: Nov. 4, 2020

Related U.S. Application Data
(60) Provisional application No. 62/930,191, filed on Nov. 4, 2019.

(51) Int. Cl. B60C 11/03; B60C 19/00; B60C 11/11

(52) U.S. Cl. CPC B60C 11/0309; B60C 11/11; B60C 11/0304; B60C 19/002

(57) ABSTRACT

The present invention provides a system and method for altering the audible sounds generated by a tire during operation by altering airflow through the tread. The tread includes tread blocks and the tread blocks include a plurality of tread block sides. Airflow through the tread blocks is altered by notches placed in the tread block sides. In an embodiment, at least one tread block side includes a notch. The notch serves to alter airflow through the tread of the tire and alter the audible sounds of the tire.

### PRIORITY

The present application claims priority to U.S. Provisional Patent Application Ser. No. 62/930,191 filed on Nov. 4, 2019 and entitled “A System and Method for Reducing Tire Noise,” which is incorporated herein in its entirety.

### BACKGROUND OF THE INVENTION

The present invention relates to a system and method for altering tire noise by diffusing airflow in tread void. Vehicles such as passenger cars and trucks typically operate on paved road surfaces. During operation, vehicles generate noise from various parameters that may be heard both inside and outside the vehicle. For example a vehicle may generate noise from its engine, exhaust, drive train, wind resistance, tires, all of which can vary according to the speed of the vehicle and condition of the paved surface. It has been desirable to utilize vehicle and tire design parameters to minimize noise created by vehicles to satisfy the comfort of vehicle occupants as well as mitigate exterior noise that is expelled into the environment.

In operation, the tires of a vehicle are a source of noise. Tires generate noise through their interaction with the road surface and the surrounding air. Tires may generate noise through vibrations created as the tire rotates and connects with the road surface. For example, vibration in the tire body may result from stimulation of the casing and tread by variations in the road surface. Noise may also be created through the mechanical pumping of air as the tread curvature comes into contact with the road. As the tread rotates and contacts the road, the tread elements move, squeezing the tread grooves when contacting the road and spreading them as the tread disengages from the road. Air trapped between the tread elements in the void area or grooves of the tire flows through the grooves to create noise. Noise may also be created by the tread pattern returning to its natural shape after disengaging with the road surface. The movement of the tread creates vibrations that may create an audible sound.

Among the factors that impact the noise generated by a tire is tread design. The size, shape, and angle of the tread elements effect how the tire interacts with the road and how the tire moves through the air. For example, circumferential tread designs have tread blocks arranged in a straight line around the circumference of the tire. Such tread designs generally have a low rolling resistance and move air through the circumferential grooves. Radial tread designs have tread blocks that are visually across a tread pattern. Radial tread designs may have a larger void area and laterally shaped grooves to increase traction on non-paved surfaces such as dirt, mud, or rocks.

One technique to reduce tire tread noise is to offset tread elements in a manner that creates a wider range of frequencies generated by the tire. In some instances the frequencies may offset, in others it is desired to avoid creating similar harmonics which may be perceived as more intense or louder tire noise. Tread offset techniques help to reduce noise in both circumferential and radial tread designs. However, it is desirable to further reduce the noise generated by a vehicle tire. It may also be desirable to alter the audible sounds generated by the tire during operation. Thus, it may be advantageous to provide a system and method to diffuse airflow through tire tread to alter tire noise.

### SUMMARY OF THE INVENTION

In an embodiment, the present invention is directed to a tire. The tire includes a tread portion and a sidewall portion. The tread portion has tread elements to form a tread pattern, wherein said tread elements include a plurality of tread blocks. The tread blocks have a plurality of tread block sides. At least one of the tread block sides has a notch. The notch may be of any size, shape, and orientation dependent upon the tread design and desired audible qualities of the tire. In an embodiment, at least one of the tread blocks is a shoulder block having a shoulder block side wherein said notch is on said shoulder block side. In an embodiment, at least one of the tread blocks is a center block having a center block side wherein said notch is on said center block side. In an embodiment, said notch is a hexagon shape. In an embodiment, a second tread block side has a notch.

Another embodiment of the present invention is directed to a system for altering audible sounds generated by the tire during operation. The system comprises a tread portion of a tire with a plurality of tread blocks. The tread blocks have a plurality of tread block sides and a notch on at least one of said tread block sides. The notch may be of any size, shape, and orientation dependent upon the tread design and desired audible qualities of the tire. In an embodiment, the notch may be located on a shoulder block side. In another embodiment, the notch may be located on a center block side.

Another embodiment of the present invention includes a method for altering audible sounds generated by the tire during operation. The method includes forming a plurality of tread blocks having tread block sides on a tread portion of a tire. The method also includes placing a notch on at least one tread block side. In an embodiment, at least one of the tread blocks is a shoulder block having a shoulder block side wherein said notch is on said shoulder block side. In an embodiment, at least one of the tread blocks is a center block having a center block side wherein said notch is on said center block side.

### BRIEF DESCRIPTION OF THE DRAWINGS

FIG. 1 is a perspective view of the tire.

FIG. 2 is a front view of the tire.

FIG. 3 is a side view of the tire.

FIG. 4 is front view of the tire.

FIG. 5 is a perspective view of the tire.

FIG. 6 is a front view of the tire.

FIG. 7 is a side view of the tire.

FIG. 8 is a front view of the tire.

FIG. 9 is a front view of the tire.

FIG. 10 is a front view of the tire.

### DETAILED DESCRIPTION OF THE INVENTION

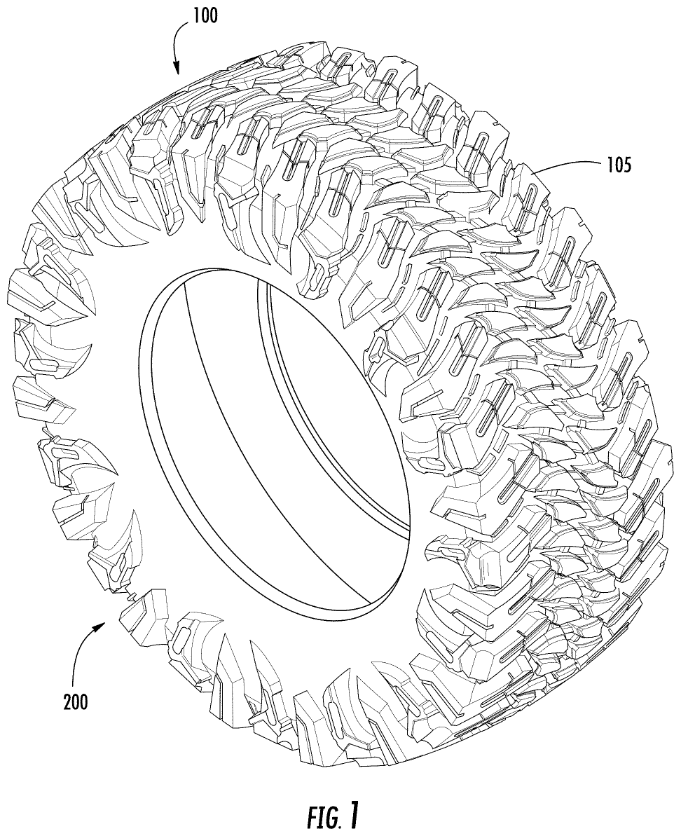

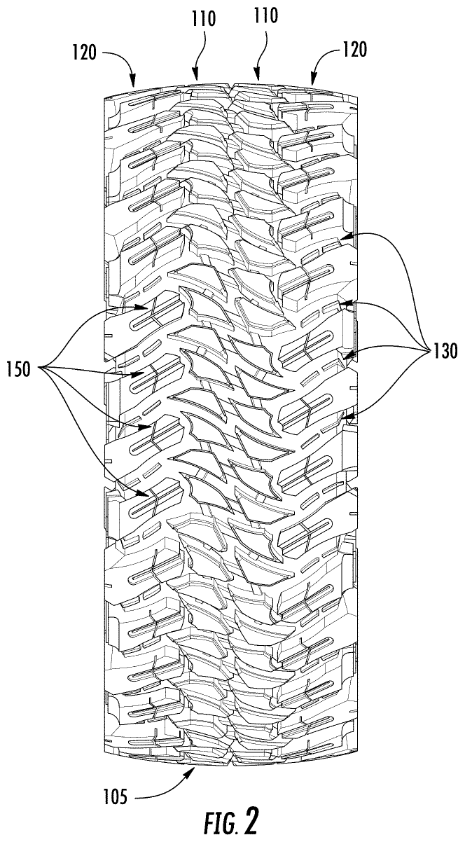

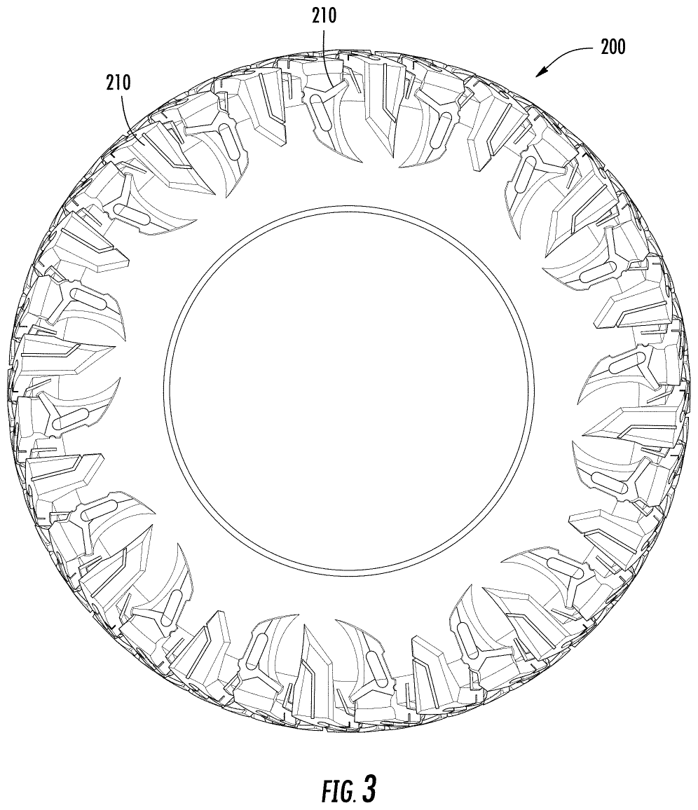

As shown in an embodiment of FIGS. 1, 2 and 3, a tire 100 typically includes a tread portion 105 and a sidewall portion 200. The tread portion 105 may include a plurality of tread elements that comprise a tread pattern. For example, the tread portion 105 includes tread elements such as center blocks 110, shoulder blocks 120, stone ejectors 130, and void area 150. As shown in FIGS. 1, 2, and 3, the center blocks 110 reside in two rows in the center of the tread portion 100 of the tire. The shoulder blocks 120 reside in two rows laterally spaced from the center blocks 110. The stone ejectors 130 reside as raised portions between the shoulder blocks 120. The void area 150 is the space between the center blocks 110, shoulder blocks 120 and stone ejectors 130. The center blocks 110, shoulder blocks 120, stone ejectors 130, and void area 150 as shown are an example and may be other shapes, sizes, or orientations. The tire 100 also has a sidewall portion 200 that includes sidewall elements such as sidewall blocks 210. The sidewall portion 200 and sidewall blocks 210 as shown are an example and may be other shapes, sizes, or orientations.

The tread portion 105 is in contact with a surface, such as a paved road or unpaved surface, such as dirt, mud, stone, rock or other surface. As the tire 100 operates, the tread portion 105 both rotates around the axis of a vehicle and travels in the direction along the surface as the vehicle moves. As the tire 100 rotates and traverses a surface, air flows between the center blocks 110, shoulder blocks 120, stone ejectors 130 and through the void area 150. Such airflow creates an audible sound that may be observed in operation. In general, the amount of airflow is related to the speed of rotation and velocity of the vehicle.

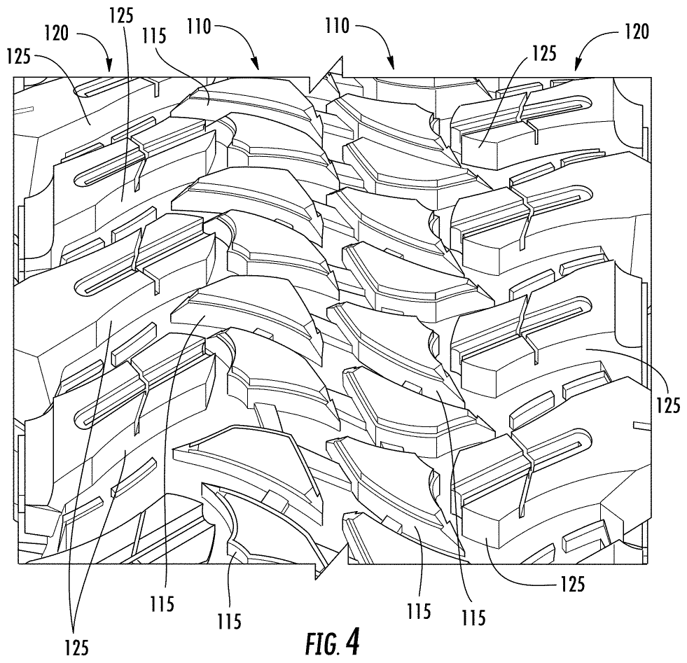

Referring now to the embodiment of FIG. 4, the center blocks 110 and shoulder blocks 120 are three-dimensional elements that have depth in relation to the void area 150. The center blocks 110 each have center block sides 115 and the shoulder block sides 125. The center block sides 115 extend from the void area 150 into a different plane to create depth for the center blocks 110. The shoulder block sides 125 extend from the void area 150 into a different plane to create depth for the shoulder blocks 120.

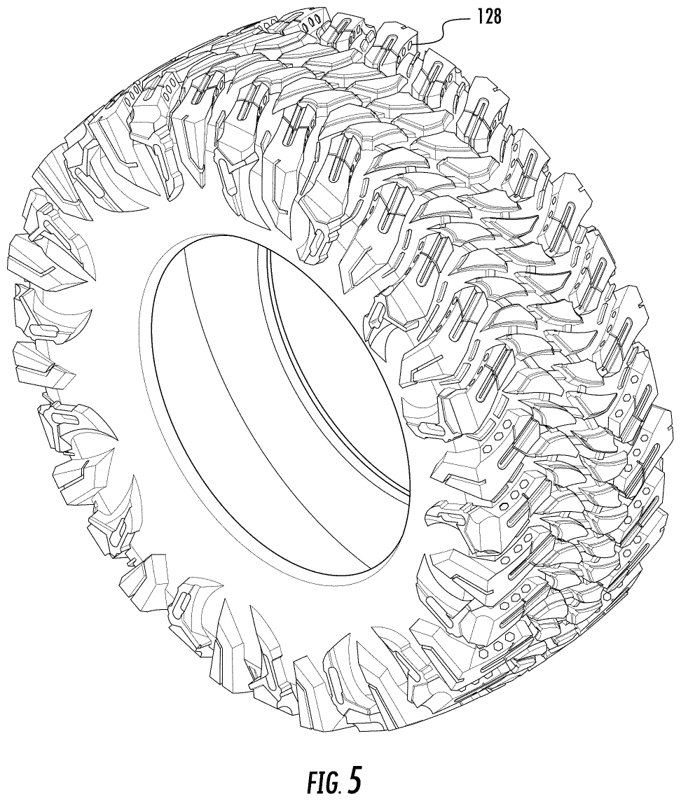

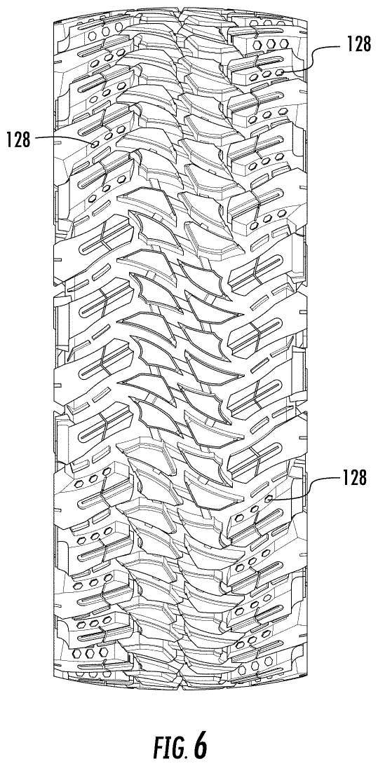

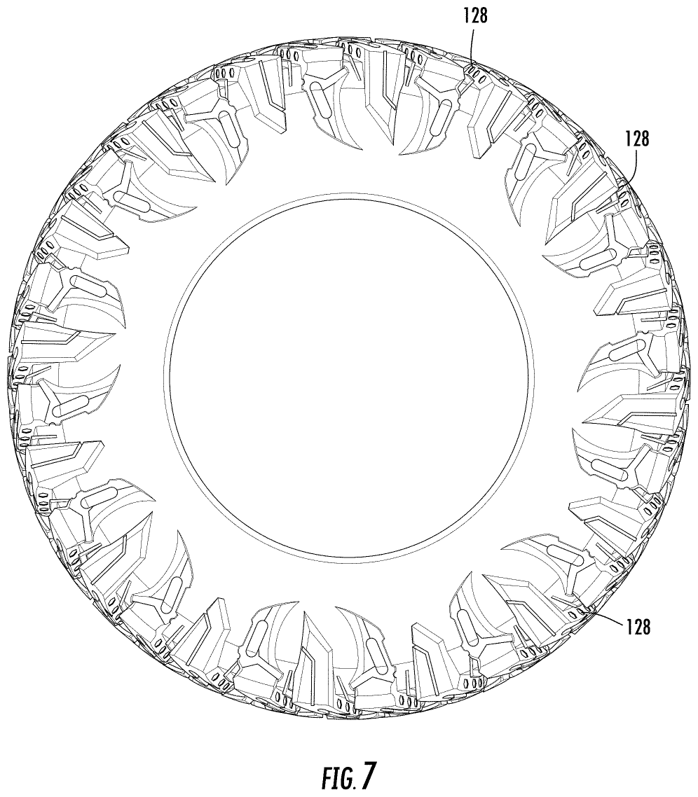

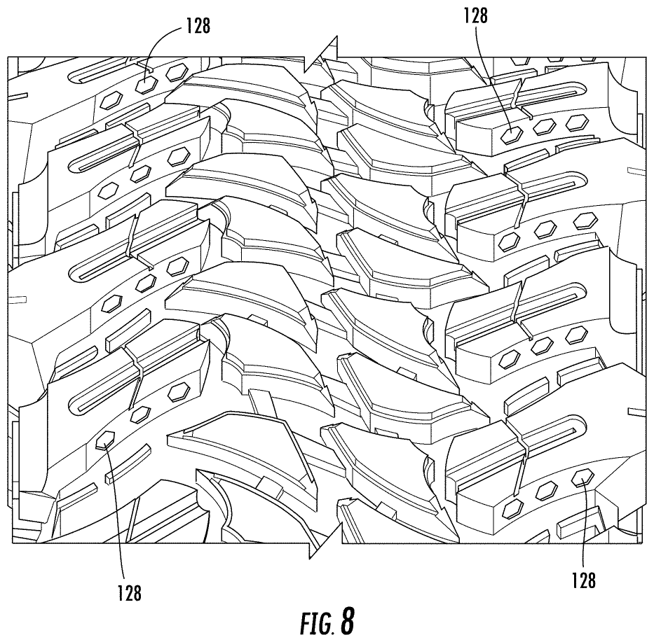

Referring now to the embodiment of FIGS. 5, 6, 7, and 8 the shoulder block sides 125 include a notch 128. The notch 128 may be an indentation in the shoulder block sides 125. A plurality of notches 128 are shown on the shoulder block sides 125 in FIGS. 5, 6, and 7. The notch(es) 128 effect how air flows among the center blocks 110, shoulder blocks 120, and stone ejectors 130 and through the void area 150. As such, the notches 128 effect the audible sound generated by air flowing among the center blocks 110, shoulder blocks 120, and stone ejectors 130 and through the void area 150. The shape, size, position, and number of notches 128 may be used as a design parameter to reduce the audible sound generated by air flowing through tread pattern 105. The notches 128 may be placed on multiple shoulder blocks sides 125 to create a desired air flow pattern.

In an embodiment as shown in FIGS. 5, 6, 7, 8, and 9, the notch 128 is hexagon shaped. The shape, size, position, and number of notches 128 affect how the air flows along the shoulder block sides 125 and thus among the center blocks 110, shoulder blocks 120, and stone ejectors 130 and through the void area 150. As air flows across the hexagon shape, the velocity and direction of the air current is altered, which alters the audible sound generated by the air flow. As shown, a plurality of notches 128 may be used to create a desired alteration in airflow to alter the audible sounds generated by the tire during operation.

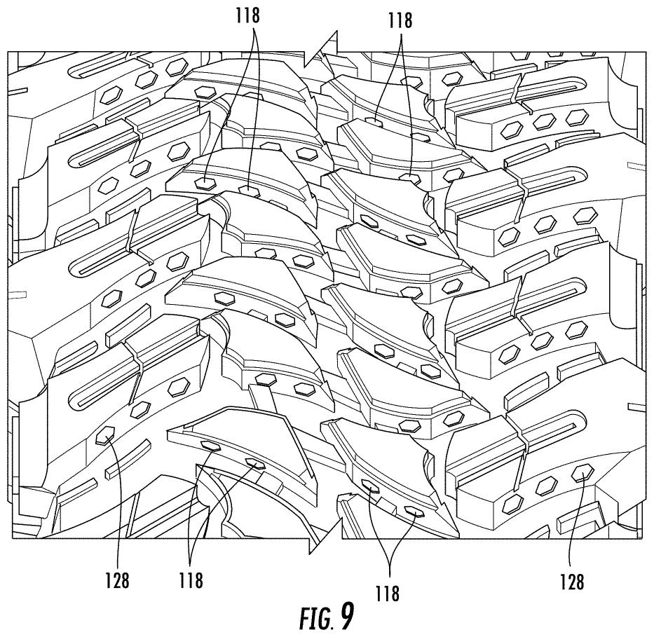

Referring now to the embodiment of FIG. 9, the shoulder block sides 125 include the notch 128 and the center block sides 115 include a notch 118. The shape, size, position, and number of notches 118 affect how the air flows along the center block sides 110 and thus among the center blocks 110, shoulder blocks 120, and stone ejectors 130 and through the void area 150. As air flows across the hexagon shape, the velocity and direction of the air current is altered, which alters the audible sound generated by the air flow. As shown, a plurality of notches may be used to create a desired alteration in airflow to alter the audible sounds generated by the tire during operation.

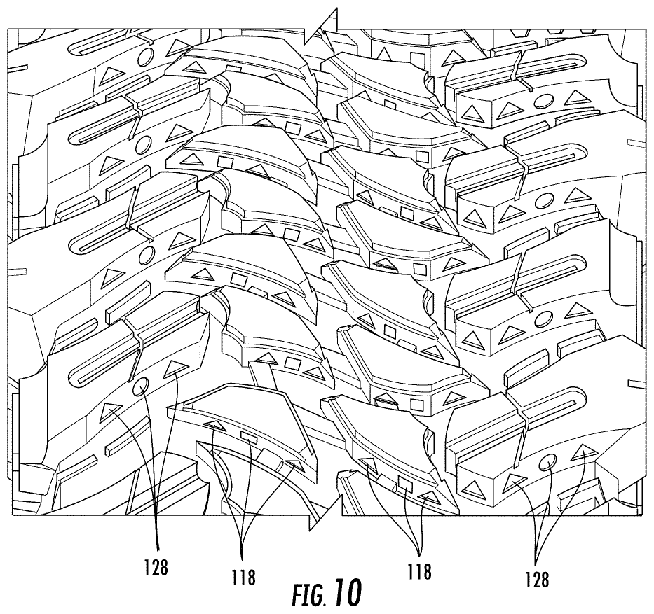

Referring now to the embodiment of FIG. 10, the shoulder block sides 125 include the notch 128 and the center block sides 115 include a notch 118. As shown in FIG. 10, the notch 128 and notch 118 may be shapes other than hexagons. As shown in FIG. 10, the notches 128 are shown in varying positions, sizes and shapes on the shoulder block sides 125. The notches 118 are shown in varying positions, sizes and shapes on the center block sides 115. The size, shape, position and orientation of notch 118 and notch 128 may be used to create a desired alteration in airflow to alter the audible sounds generated by the tire during operation.

A person of ordinary skill in the art would recognize that modifying the size, shape and orientation of the notches can change how air flow through tire tread and change the audible sound of a tire's tread. Modifying the size, shape and orientation of the notches may be used to minimize the audible sound of a tire's tread. Alternatively, modifying the size, shape, and orientation of the notches may be used to achieve a desired audible sound of a tire's tread.

In an embodiment, the present invention includes a method for influencing air flow through the tread pattern of a tire. Influencing the air flow through the tread pattern of a tire can alter the audible sounds generated by the tire during operation. The method includes forming a plurality of tread blocks having tread block sides on a tread portion of a tire and placing a notch on at least one tread block side. The placement, shape, and size of the notches can be used to alter the audible sounds generated by the tire during operation. In an embodiment, the notches may be used to reduce tire noise. In another embodiment, it is contemplated that the notches may be designed to generate a desirable audible sound of the tire tread. The method further includes a tire tread where one of the tread blocks is a shoulder block having a shoulder block side and one of the tread blocks is a center block having a center block side. The should block and center blocks sides may have one or more notches to influence air flow and alter the audible sounds of the tire tread pattern.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation.

1. A tire comprising:
a tread portion and a sidewall portion;
said tread portion having tread elements to form a tread pattern, wherein said tread elements include a plurality of tread blocks;
said tread blocks having a plurality of tread block sides;
wherein at least one tread block side has a notch.

2. A tire according to claim 1, wherein at least one of the tread blocks is a shoulder block having a shoulder block side.

3. A tire according to claim 2, wherein said notch is on said shoulder block side.

4. A tire according to claim 1, wherein at least one of the tread blocks is a center block having a center block side.

5. A tire according to claim 4, wherein said notch is on said center block side.

6. A tire according to claim 1, wherein said notch is a hexagon shape.

7. A tire according to claim 1, wherein a second tread block side has a notch.

8. A system for altering audible sounds generated by the tire during operation, said system comprising:
a tread portion of a tire;
a plurality of tread blocks having a plurality of tread block sides; and,
a notch on at least one of said tread block sides.

9. A system according to claim 8, wherein at least one of the tread blocks is a shoulder block having a shoulder block side.

10. A system according to claim 9, wherein said notch is on said shoulder block side.

11. A system according to claim 8, wherein at least one of the tread blocks is a center block having a center block side.

12. A system according to claim 11, wherein said notch is on said center block side.

13. A system according to claim 8, wherein said notch is a hexagon shape.

14. A system according to claim 8, wherein a second tread block side has a notch.

15. A method for altering audible sounds generated by the tire during operation, said method comprising:
forming a plurality of tread blocks having tread block sides on a tread portion of a tire;
placing a notch on at least one tread block side.

16. The method of claim 15, wherein at least one of the tread blocks is a shoulder block having a shoulder block side.

17. The method of claim 16, wherein said notch is on said shoulder block side.

18. The method of claim 15, wherein at least one of the tread blocks is a center block having a center block side.

19. The method of claim 18, wherein said notch is on said center block side.

20. The method of claim 15, wherein said notch is a hexagon shape.
